(19) United States
(12) Patent Application Publication
(10) Pub. No.: US 2017/0184011 A1
(43) Pub. Date: Jun. 29, 2017

(54) CHARGE AIR COOLER FOR AN INTERNAL COMBUSTION ENGINE AND METHOD FOR OPERATING A CHARGE AIR COOLER

(71) Applicant: AUDI AG, Ingolstadt (DE)

(72) Inventors: ANDREAS KOPP, Kosching (DE); MANUEL WETZKA, Wettstetten-Echenzell (DE); TOBIAS FICKENSCHER, Ingolstadt (DE)

(73) Assignee: AUDI AG, Ingolstadt (DE)

(21) Appl. No.: 15/388,690

(22) Filed: Dec. 22, 2016

(30) Foreign Application Priority Data
Dec. 23, 2015 (DE) 10 2015 016 812.6

(51) Int. Cl. F02B 29/04; F28F 27/02; F28F 17/00

(52) U.S. Cl. CPC F02B 29/0462; F02B 29/0456; F28F 17/00; F28F 27/02

(57) ABSTRACT

A charge air cooler for an internal combustion engine, includes a charge air inlet and a charge air outlet which are fluidly connected with each other via multiple charge air channels which are arranged parallel to each other and arranged parallel to each other and subjectable to a coolant flow; and at least one flow guide element arranged upstream of the charge air channels, wherein the flow guide element at least in one operating state of the internal combustion engine deflects charge air entering through the charge air inlet the direction of a condensate accumulation volume of the charge air cooler.

### CROSS-REFERENCES TO RELATED APPLICATIONS

This application claims the priority of German Patent Application, Serial No. 10 2015 016 812.6, filed Dec. 23, 2015, pursuant to 35 U.S.C. 119(a)-(d), the content of which is incorporated herein by reference in its entirety as if fully set forth herein.

### BACKGROUND OF THE INVENTION

The invention relates to a charge air cooler for an internal combustion engine.

The following discussion of related art is provided to assist the reader in understanding the advantages of the invention, and is not to be construed as an admission that this related art is prior art to this invention.

The charge air cooler is assigned to the internal combustion engine, which for example serves for driving a motor vehicle, i.e., for providing a torque that is directed towards driving the motor vehicle. The internal combustion engine is charged. This means that a compressor is assigned to the internal combustion engine which upstream of the internal combustion engine compresses fresh gas conducted to the internal combustion engine, i.e., brings the fresh gas to a higher pressure level. The fresh gas is for example fresh air or at least temporarily a fresh air exhaust gas mixture if the internal combustion engine has an external exhaust gas return. The charging results in a higher power and/or a higher efficiency of the internal combustion engine. The compressor is for example a component of a charger in particular an exhaust gas turbocharger or of an electrically supported exhaust gas turbocharger or a compressor. The compressor can also be present as an electrically driven compressor.

As a result of the compression of the fresh gas by means of the compressor the temperature of the fresh gas significantly rises due to the higher pressure and the performed compression work. Because correspondingly the density of the fresh gas decrease the temperature increase of the fresh gas leads to a decrease of the power and/or efficiency increase. For this reason the charge air cooler is fluidly provided between the compressor and the internal combustion engine. The fresh gas, in the following also referred to as charge air, compressed by means of the compressor is supplied to the charge air cooler by the charge air inlet. Subsequently the charge air flows trough the charge air channels which are arranged fluidly parallel to each other and then flows out through the charge air outlet out of the charge air cooler. Subsequently the charge air or the compressed fresh gas is supplied to the internal combustion engine.

Correspondingly the charge air inlet is fluidly arranged on the side of the charge air cooler that faces the compressor and the charge air outlet is arranged on the side that faces the internal combustion engine. Via the charge air channels the charge air outlet is fluidly connected with the charge air inlet, in particular exclusively. The charge air channels are preferably arranged parallel to each other, i.e., for example their longitudinal center axes extend parallel to each other. Preferably the charge air channels are arranged spaced apart from each other, i.e. in particular spaced apart in parallel from each other, so that coolant an flow between them. The coolant serves for discharging heat from the charge air. Correspondingly the coolant has preferably a lower temperature than the charge air flowing through the charge air channels.

The charge air usually contains a certain amount of water. When the charge air is strongly cooled in the charge air channels in particular to below its dew point this water precipitates out of the charge air as condensate. In the case of a great charge air mass flow through the charge air cooler most of the condensate is immediately entrained by the charge air and together with the charge air supplied to the internal combustion engine. The mass flow of condensate or liquid water supplied to the internal combustion engine is in this case so small that no adverse effects are expected.

However when the exhaust gas mass flow is small, for example in a partial load range of the internal combustion engine, the generated condensate may accumulate in the charge air cooler, in particular in the charge air channels. When the charge air mass flow subsequently increases large amounts of condensate may be entrained by the charge air and enter the internal combustion engine. Because this may negatively affect combustion in the internal combustion engine means can be provided to conduct the liquid water out of the charge air cooler. However, these means are oftentimes constructively complicated and cost-intensive.

It would be desirable and advantageous to provide a charge air cooler for an internal combustion engine, which has advantages compared to known charge air coolers and in particular reliably prevents accumulation of condensate in the charge air cooler.

### SUMMARY OF THE INVENTION

According to one aspect of the present invention a charge air cooler for an internal combustion engine includes a charge air inlet and a charge air outlet which are fluidly connected with each other via multiple charge air channels which are arranged parallel to each other and arranged parallel to each other and subjectable to a coolant flow; and at least one flow guide element arranged upstream of the charge air channels, wherein the flow guide element at least in one operating state of the internal combustion engine deflects charge air entering through the charge air inlet the direction of a condensate accumulation volume of the charge air cooler

The air guide element is thus for example assigned to the charge air cooler and serves for deflecting the charge air that flows in through the charge air inlet and/or flows in the direction of the charge air channels. The deflection of the charge air by the flow guide element is hereby accomplished in such a manner so that the charge air flows in the direction of the condensate accumulation volume of the charge air cooler. The condensate accumulation volume is for example formed by at least one of the charge air channels, in particular by a geodetically lowest one of the charge air channels. The generated condensate is urged into this charge air channel due to gravity.

The deflection of the charge air by means of the flow guide element is provided at least in the at least one operating state of the internal combustion engine. Preferably the flow guide element is hereby arranged so that it ensures an flow of the charge air into the charge air channel that has the condensate accumulation volume or the charge air channels having the condensate accumulation volume also in the case of small charge air mass flows. This prevents condensate from accumulating in the charge air cooler, in particular in the condensate accumulation volume, also in the case of small charge air mass flows. Also in the case of a sudden increase of the charge air mass flow an abrupt increase of the amount of condensate conducted to the internal combustion engine is prevented thereby avoiding the negative effects on combustion.

The charge air entering the charge air inlet preferably directly flows against the flow guide element. Preferably the flow guide element is fluidly situated between the charge air inlet and one of the charge air channels that is situated closest to the charge air inlet. Without the flow guide element the charge air would preferably flow into this charge air channel, which is closest to the charge air inlet. The flow guide element however deflects the charge air from this charge air channel so that the charge air flows in the direction of the one of the charge air channels that is arranged further away from the charge air inlet, and in particular flows into this charge air channel. This charge air channel preferably has at least a part of the condensate accumulation volume.

According to another advantageous feature of invention, the charge air cooler is configured as a direct charge air cooler, wherein the coolant is ambient air, or as indirect charge air cooler, wherein the coolant is cooling fluid, in particular a refrigerant. The direct charge air cooling is arranged so that ambient air can directly flow through it. The ambient air is thus intended to flow, for example due to a speed-induced ambient air flow, against the charge air channels and/or around the charge air channels or flow through the charge air channels.

As an alternative the charge air cooler can of course be configured as an indirect charge air cooler. In this case it is not directly exposed to the speed-induced ambient air stream. Rather the cooling fluid is supplied to the charge air cooler, which can at least temporarily be liquid and is circulated in a coolant circuit, in particular a coolant circuit of the internal combustion engine. The cooling fluid can be present in the form of a refrigerant.

According to another advantageous feature of invention, the condensate accumulation volume is present in at least one geodetically lowermost one of the charge air channels. As explained above the condensate generated in the charge air cooler is urged downwardly due to gravity. Correspondingly it first collects in the charge air channels that in the installed state are positioned at a bottommost position. Of course a portion of the condensate can also accumulate in multiple ones of the charge air channels, in particular the geodetically bottommost charge air channels of the charge air cooler.

According to another advantageous feature of invention, a charge air distribution box can be provided between the charge air inlet and the charge air channels, in which the flow guide element is arranged. The charge air inlet is for example an entry opening of a charge air conduit in the charge air distribution box, wherein via the charge air conduit the charge air is supplied to the charge air cooler. In the direction of the greatest extent of the totality of the charge air channels of the charge air cooler usually the charge air conduit or its entry opening has smaller dimensions than the charge air channels.

Correspondingly it is necessary to split up the charge air so that the charge air can be supplied to the charge air channels. For this purpose the charge air distribution box is provided, into which the charge air conduit enters on one side charge air distribution box and the charge air channels extend from the other side of the charge air distribution box. The charge air distribution box thus operates in the manner of a diffuser. For example the charge air conduit enters geodetically approximately centrally into the charge air distribution box. On the side of the charge air channels that is opposite the charge air distribution box the charge air channels can enter into a charge air accumulation box. Assigned to the charge air accumulation box is the charge air outlet. In the charge air accumulation box the charge air flowing through the charge air channels is thus combined and subsequently together discharged in the direction of the internal combustion engine.

According to another advantageous feature of invention, the flow guide element is arranged in the charge air distribution box, in particular in the region of the entry opening. Correspondingly the charge air flowing into the charge air distribution box flows directly against the flow guide element and not only after being deflected by the charge air distribution box or by a wall of the charge air distribution box. The flow guide element is present in the charge air distribution box, in particular it extends from the wall of the charge air distribution box. The flow guide element preferably fastened or supported on the wall. In particular the flow guide element extends in at least one direction through the entire charge air distribution box, i.e., from one wall to an opposite wall of the charge air distribution box. It can also be provided that the flow guide element traverses the charge air distribution box only partially, i.e., it only bridges a part of the distance between the opposing walls. This part corresponds with respect to the distance between the walls at least 25%, at least 50%, at least 75%, at least 90% or at least 95%.

According to another advantageous feature of invention, the charge air flows into the charge air distribution box through the charge air inlet with an inflow direction which lies in a flow plane which is perpendicular to a longitudinal center plane of the charge air channels, wherein the flow guide element deflects the charge air in such a manner so that the charge air flows away from the flow plane. The longitudinal center axis of the charge air channels is a plane which takes up the longitudinal center axes of multiple ones of the charge air channels, in particular all charge air channels of the charge air cooler. Correspondingly it extends for example in geodetic vertical direction or encloses with this direction a small angle of at most 15°, at most 10° or at most 5°.

The flow plane is perpendicular to this longitudinal center plane and at the same time takes up the inflow direction of the charge air flowing into the charge air distribution box. The inflow direction hereby means preferably the main flow direction of the charge air entering the charge air distribution box. The flow guide element is arranged in the charge air flow so that the charge air is deflected into a direction which faces away from the flow plane. The deflection hereby occurs preferably in the direction of a geodetically lower side of the flow plane.

According to another advantageous feature of invention, the flow guide element can have a flow profile. The flow guide element is for example wing-shaped. With such a configuration of the flow guide element an acceleration of the deflected charge air can be achieved. Due to the higher velocity the charge air can entrain a greater portion of the condensate present in the condensate accumulation volume in the direction of the internal combustion engine. This in particular applies when multiple flow guide elements are present which are preferably arranged spaced apart from each other in the charge air distribution box.

According to another advantageous feature of invention, the flow guide element can be adjustable. The flow guide element is thus assigned an actuator by means of which for example an angle of attack of the flow guide element can be adjusted. The angle of attack can be selected and adjusted in dependence on the operating state of the internal combustion engine, in particular in dependence on a charge air mass flow. The adjustability of the flow guide element allows realizing a stronger deflection of the charge air in a partial load range of the internal combustion engine than at full load for which a greater charge air mass flow is present.

in the latter case the condensate is discharged out of the charge air cooler in sufficient amounts also in the absence of deflection of the charge air by the flow guide element. At the same time as a result of the smaller deflection the pressure loss of the charge air cooler for the charge air is reduced. Particularly preferably in at least one operating state of the internal combustion engine, for example at full load, the charge air is not deflected at all of by the flow guide element or at least only to a degree which corresponds to a deflection which is minimally adjustable by means of the flow guide element.

c the adjustable flow guide element can be used to periodically supply the charge air to different charge air channels. For example for this purpose a sequence is set towards which charge air channel the charge air is to be deflected by means of the flow guide element. The charge air channels towards which the charge air is to be deflected preferably form a subset of all charge air channels of the charge air cooler. This subset may only include a part of the charge air channels but also all of the charge air channels. When the subset includes only a part of the charge air channels, the subset includes multiple charge air channels that are preferably located further downwards in geodetic direction, in particular multiple charge air channels that are situated furthest down in the geodetic direction.

The flow guide element is used to periodically deflect the charge air in the direction of a charge air channel of the subset, so that this charge air channel is predominantly impinged with the charge air. For example switching to another charge air channel of the subset is performed in defined time intervals so that within a dewatering cycle the charge air is in each case deflected in the direction of the charge air channel included in the subset. Thus in the dewatering cycle the charge air channel contained in the subset is impinged once predominantly with the charge air or by the charge air deflected in its direction. Correspondingly the condensate is removed particularly effectively from of the charge air channel. In addition already the formation of the condensate can be prevented in the respective charge air channel.

In such an approach the flow guide element is periodically adjusted so that the charge air is deflected in the direction of different charge air channels. During the dewatering cycle the charge air thus flows over multiple charge air channels as a result of the adjustment of the flow guide element, in particular over all charge air channels. The periodic adjustment can be performed permanently or in dependence on at least one environmental condition and/or the operating state of the internal combustion engine. As environmental condition for example an ambient temperature can be used. In particular the adjustment is only performed when the ambient temperature falls below a temperature threshold value. As an alternative or in addition the adjustment is only performed when a defined operating state of the internal combustion engine is present, in particular when the internal combustion engine is operated at partial load. On the other hand at full load and/or when exceeding the temperature threshold value, the flow guide element can be adjusted so that a smallest possible pressure loss or flow resistance is obtained, i.e., in particular in such a manner that the charge air is not deflected or at least only to a degree so that the minimally adjustable deflection is obtained.

According to another aspect of the present invention a method for operating a charge air cooler for an internal combustion engine, includes providing a charge air cooler which includes a charge air inlet and a charge air outlet which are fluidly connected with each other via multiple charge air channels, wherein the multiple charge air channels are arranged parallel to each other and subjectable to a coolant flow; and with a flow guide element of the charge air cooler arranged upstream of the charge air channels, deflecting in at least one operating state of the internal combustion engine charge air entering through the charge air inlet in a direction of a condensate accumulation volume of the charge air cooler

According to another advantageous feature of invention, the flow guide element can be adjustable and an angle of attack of the flow guide element is selected and adjusted in dependence on the operating state. This was already mentioned above. For example the angle of attack is determined, in particular calculated, in dependence on at least one operating variable of the internal combustion engine. As operating variable for example the torque, the rotational speed of the internal combustion engine or the charge air mass flow can be used. The angle of attack is determined by way of exactly one of the mentioned operating variables or multiple operating variables, in particular all mentioned operating variables.

According to another advantageous feature of invention, the flow guide element can be adjusted so that the charge air is deflected the stronger the smaller a charge air mass flow flowing through the charge air is, and/or is deflected the stronger the greater the charge air mass flow is. Particularly preferably when the charge air mass flow exceeds a charge air mass flow threshold value no deflection of the charge air by the flow guide element is performed.

However, when the charge air mass flow is smaller than the charge air mass flow threshold value the deflection can be set the stronger the smaller the charge air mass flow is. This ensures that on one hand at a low charge air mass flow the condensate is reliably removed from the charge air cooler and on the other hand a small pressure loss of the charge air cooler at a greater charge air mass flow.

### BRIEF DESCRIPTION OF THE DRAWING

Other features and advantages of the present invention will be more readily apparent upon reading the following description of currently preferred exemplified embodiments of the invention with reference to the accompanying drawing, in which

FIG. 1 shows a schematic representation of a first embodiment of a charge air cooler for an internal combustion engine; and

FIG. 2 shows a schematic representation of a second embodiment of the charge air cooler.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

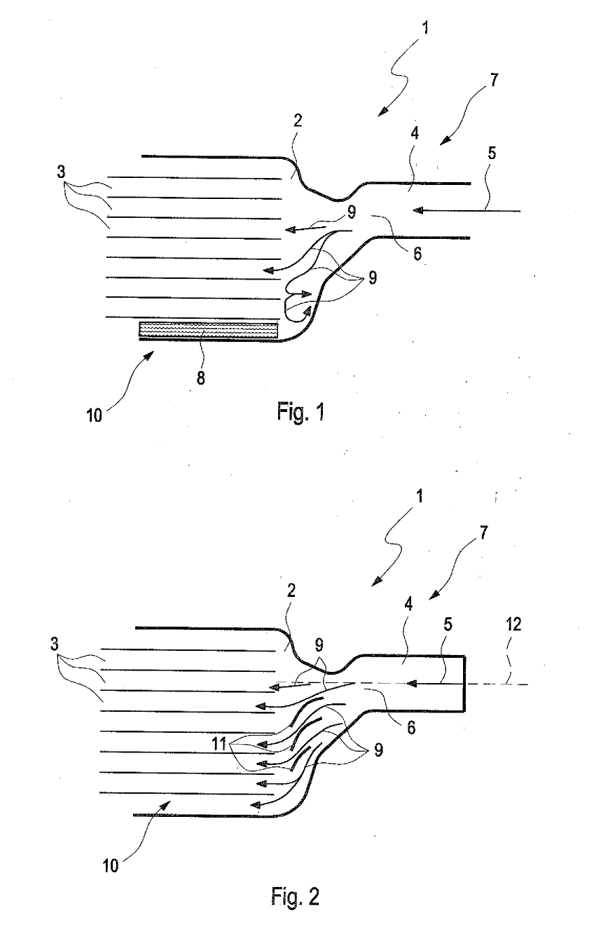

FIG. 1 shows a schematic representation of a region of a charge air cooler 1, which has a charge air distribution box 2 and charge air channels 3 extending therefrom (of which in this case only some are exemplarily indicated). Charge air is supplied to the charge air distribution box 2 via a charge air conduit 4, wherein the inflow direction of the charge air is indicated by the arrow 5. The charge air conduit 4 enters into the charge air distribution box 2 at an entry opening 6.

It can be seen that downstream of the entry opening 6 the flow cross section becomes wider because the charge air channels 3 in their totality have greater dimensions in at least one direction than the charge air conduit 4 or the entry opening 6. The charge air conduit 4 is assigned to a charge air inlet 7 of the charge air cooler 1. The charge air flowing into the charge air distribution box 2 enters the charge air channels 3 or at least a part of the charge air channels 3 and flows through the same. On the side of the charge air channel 3 that faces away from the charge air distribution box 2 the charge air channels 3 are preferably connected to a charge air accumulation box which is assigned to a (here not shown) charge air outlet of the charge air cooler 1.

In particular in the case of a small charge air mass flow it may occur that the charge air entering the charge air distribution box 2 is distributed preferably to the charge air channels 3 that are situated in flow direction, i.e., in the direction of the arrow 5, while distal charge air channels 3 are not impinged with charge air or only to a minor degree. Because the charge air is cooled in the charge air cooler 1 water can be condensed in the charge air cooler when cooling is performed below the dew point, and can be present in the form of condensate 8 in the charge air cooler 1.

Due to gravity the condensate 8 accumulates preferably in a geodetically lowermost one of the charge air channels 3, as indicated in the present case. At the same time this charge air channel, due to its distance to the entry opening 6, however charge air no longer flows through this charge air channel to a sufficient degree in order to remove the condensate. This is indicated by the arrows 9. Rather it is clear that even backflow regions may form which prevent the entry of charge air into the charge air channel 8 containing the condensate 8. The region in which the condensate 8 accumulates can be referred to as condensate accumulation volume 10.

In order to enable a uniform removal of condensate 8 from the charge air cooler 12 also at low charge air mass flows at least one flow guide element 11 is assigned to the second configuration of charge air cooler 1 as illustrated in FIG. 2. In the shown exemplary embodiment multiple flow guide elements 11 are provided which are arranged spaced apart form each other. The flow guide element is preferably present in the charge air distribution box 2. The flow guide element 11 is oriented so that the charge air flowing in through the charge air inlet 7 is deflected in the direction of the condensate accumulation volume 10 in at least one operating state of the internal combustion engine. As explained above the condensate accumulation volume is present in the at least one charge air channel which geodetically is situated lowermost.

The charge air is hereby deflected by the flow guide element 11 away from the here only schematically indicated flow plane 12, which encompasses the inflow direction indicated by the arrow 5 and is perpendicular to a longitudinal center plane of the charge air plane 3. In particular the flow guide element 11 deflects the charge air in the direction of the geodetically lowermost charge air channel 3. The arrows 9 indicate that by means of the flow guide element 11 an equalization of the charge air mass flow through the charge air channels 3 can be achieved or that even the predominant portion of the charge air flows to the lower most ones of the charge air channels.

In this way the condensate 8 is reliably removed from the condensate accumulation volume 10 and entrained in the direction of the internal combustion engine even at lower charge air mass flows. Also in the case of a sudden increase of the charge air mass flow no abrupt increase of the condensate amount entrained by the charge air can thus occur. Correspondingly a negative influence on the operation of the internal combustion engine is reliably prevented.

What is claimed as new and desired to be protected by Letters Patent is set forth in the appended claims and includes equivalents of the elements recited therein:

What is claimed is:

1. A charge air cooler for an internal combustion engine, comprising:
a charge air inlet and a charge air outlet fluidly connected with each other via multiple charge air channels, said multiple charge air channels being arranged parallel to each other and subjectable to a coolant flow; and
at least one flow guide element arranged upstream of the charge air channels, said flow guide element at least in one operating state of the internal combustion engine deflecting charge air entering through the charge air inlet the direction of a condensate accumulation volume of the charge air cooler.

2. The charge air cooler of claim 1, configured as a direct charge air cooler with the coolant being ambient air, or as indirect charge air cooler with the coolant being a cooling fluid.

3. The charge air cooler of claim 2, wherein the cooling fluid is a refrigerant.

4. The charge air cooler of claim 1, wherein the condensate accumulation volume is present in at least one geodetically lowermost ones of the charge air channels.

5. The charge air cooler of claim 1, further comprising a charge air distribution box arranged fluidly between the charge air inlet and the charge air channels, in said flow guide element being arranged in the charge air distribution box.

6. The charge air cooler of claim 5, wherein the charge air flows into the charge air distribution box through the charge air inlet with an inflow direction which is located in a flow plane which is perpendicular to a longitudinal center plane of the charge air channels, and wherein the flow guide element deflects the charge air so that the charge air flows away from the flow plane.

7. The charge air cooler of claim 1, wherein the flow guide element has a flow profile.

8. The charge air cooler of claim 1, wherein the flow guide element is adjustable.

9. A method for operating a charge air cooler for an internal combustion engine, in particular a charge air cooler, said method comprising:
providing a charge air cooler comprising a charge air inlet and a charge air outlet which are fluidly connected with each other via multiple charge air channels, said multiple charge air channels being arranged parallel to each other and subjectable to a coolant flow; and
with a flow guide element of the charge air cooler arranged upstream of the charge air channels, deflecting in at least one operating state of the internal combustion engine charge air entering through the charge air inlet in a direction of a condensate accumulation volume of the charge air cooler.

10. The method of claim 9, wherein the flow guide element is adjustable, said method further comprising selecting and adjusting an angle of attack of the flow guide element in dependence on the operating state.

11. The method of claim 9, further comprising adjusting the flow guide element so that the charge air is deflected the stronger the smaller a charge air mass flow flowing through the charge air cooler is, and/or so that the charge air is deflected the stronger the greater the charge air mass flow is.
